(19) United States
(12) Patent Application Publication
(10) Pub. No.: US 2014/0270128 A1
(43) Pub. Date: Sep. 18, 2014

(54) CONTENT DISPLAY TERMINAL SELECTION SYSTEM

(71) Applicant: NEC CORPORATION, Minato-ku, Tokyo (JP)

(72) Inventor: Akiko Suito, Minato-ku (JP)

(73) Assignee: NEC CORPORATION, Minato-ku, Tokyo (JP)

(21) Appl. No.: 14/353,325

(22) PCT Filed: Oct. 22, 2012
(86) PCT No.: PCT/JP2012/006733

§ 371 Date: Apr. 22, 2014

(30) Foreign Application Priority Data
Nov. 8, 2011 (JP) 2011-244700

(51) Int. Cl. H04M 3/42

(52) U.S. Cl. CPC H04M 3/4228
USPC 379/201.02

(57) ABSTRACT

Call information acquiring means 111 and 161 each acquire call session information of a call established between a user's call terminal 100 and an operator's call terminal 170. A content display terminal selecting means 103 causes the user to select a display terminal to be used for displaying content. A session managing means 151 records the call session information acquired by the call information acquiring means 111 and 161, terminal identification information of a display terminal 130 selected with the content display terminal selecting means 103, and terminal identification information of an operator's display terminal 180, in association with each other into a storage part 153, and when getting a WEB access, transmitting the same content to the user's display terminal 130 and the operator's display terminal 180 whose terminal identification information are recorded in association with the same call session information.

### TECHNICAL FIELD

The present invention relates to a content display terminal selection system capable of making content displayed on a display terminal selected by a user during a conversation on the phone identical to content displayed on a display terminal of the other party.

### BACKGROUND ART

There is a remote support service that, in a case where a personal computer (PC) of a user breaks down or a user does not know how to operate, an operator in a support center and the user share the screen of the user PC while talking on the phone and the operator remotely controls the screen of the PC. In such a conventional remote support service, the user calls the support center to get a “receipt number.” After that, when the user starts a remote control program on his/her PC and enters the “receipt number” into the remote control program, a session is established between the user PC and an operator terminal, and the operator terminal is enabled to remotely control the user PC.

However, in a case where a terminal, such as a DVD (Digital Versatile Disk) recorder, that does not have an operation screen breaks down, or in a case where a terminal that the user wants to know how to operate is a terminal that does not have a communication function, the user cannot get support by remote control by sharing the screen as described above. In a case where a target terminal (a DVD recorder and the like) cannot be remotely controlled directly by the operator, the user calls the operator and operates the target terminal in accordance with an instruction by the operator. However, the user may be unable to solve the problem because of the user's wrong hearing of the operator's oral instruction or the user's incorrect understanding of how to operate. In such a case, by displaying the same manual on both the display of a terminal other than the support target terminal in the user's house and the display of the operator terminal, the user can understand an instruction by the operator more easily, and the operator can give a clear instruction by using the manual.

A manual may be displayed on the display of a call terminal used for a conversation with the operator. However, because the display of the call terminal generally has a small screen display region, it is hard for the user to read letters because the letters are compressed when the whole page of the manual is displayed, whereas the user can read only part of the page when the manual is enlarged. Thus, it is desired to select a terminal equipped with a display having a display region enough to display the manual from among a plurality of terminals that the user can use.

An example of a system that the user selects a terminal for displaying content from among a plurality of terminals in the user's house is described in Patent Document 1. Content is a collective term of media such as a still image like a photo, a document containing a text and an image, and a moving image like a video image.

The system described in Patent Document 1 has a configuration that, for displaying an image on a display device, a user enters an image display request into a display device selection apparatus realized by a mobile information terminal and the like. Consequently, the display device selection apparatus communicates with a plurality of display devices existing in the user's house, and collects the types of display applications (WEB browser, MPEG player, and so on) installed in the respective display devices. After that, based on the collected information, the display device selection apparatus extracts display devices capable of displaying a display-requested image from among the display devices existing in the user's house. Then, the display device selection apparatus assigns an operation interface to each of the extracted display devices, and causes the screen of each of the display devices to display operation interface information showing the operation interface assigned to the display device. The operation interface information is, for example, the number of a button provided on the display device selection apparatus.

The user selects a display device for displaying an image from among the display devices whose operation interface information are displayed, and operates the corresponding operation interface. For example, when the user wants to display an image on a display device H2 with information showing “button 2” displayed as the operation interface information, the user pushes down a button 2 provided on the display device selection apparatus. Thus, the display device selection device transmits a display order to the selected display device H2 and causes the display device H2 to display the image.

Further, an example of a system that displays the same content on both a display terminal of a user and a display terminal of the other party while the user is talking by using a communication terminal is described in Patent Document 2.

The system described in Patent Document 2 has a configuration that an association between a user's SIP phone used by the user and a user's display terminal used in combination with the user's SIP phone is previously recorded in a user's home gateway (the user's HGW) and an association between an operator's SIP phone used by the other party (an operator) and an operator's display terminal used in combination with the operator's SIP phone is previously recorded in an operator's HGW.

When communication between the user's SIP phone and the operator's SIP phone is established, the user's HGW passes CALL session information C for uniquely identifying the above communication and an instruction to redirect to a service providing device, to the user's display terminal under the user's HGW. The operator's HGW also executes the same process.

Upon receiving the redirect instruction, the user's display terminal changes an access destination to the service providing device, and transmits the CALL session information C to the service providing device. The operator's display terminal also executes the same process.

Upon receiving the CALL session information C from one of the display terminals, for example, from the user's display terminal, the service providing device delivers and transmits WEB session information W1 given to WEB communication performed by the user's display terminal, to the user's display terminal, and also records the CALL session information C and the WEB session information W1 in association with each other. On the other hand, upon receiving the CALL session information C from the other display terminal, that is, from the operator's display terminal, the service providing device delivers and transmits WEB session information W2 given to WEB communication performed by the operator's display terminal, to the operator's display terminal, and also records the CALL session information C and the WEB session information W2 in association with each other. Through these processes, the CALL session information C relating to the communication established between the user's SIP phone and the operator's SIP phone, the WEB session information W1 relating to WEB communication performed by the user's display terminal, and the WEB session information W2 relating to WEB communication performed by the operator's display terminal are recorded in association with each other.

From this point, the service providing device controls the WEB communication provided with the WEB session information W1 and the WEB communication provided with the WEB session information W2 in association with each other. For example, in a case where the operator's display terminal uploads content displayed on the terminal itself by the WEB communication provided with the WEB session information W2 while the user's display terminal is accessing the service providing device by the WEB communication provided with the WEB session information W1, the service providing device transmits the content to the user's display terminal and causes the user's display terminal to display the content.
Patent Document 1: Japanese Patent No. 4628305
Patent Document 2: Japanese Unexamined Patent Application Publication No. 2009-176289

According to the technique described in Patent Document 1, the user can select a display device for displaying an image from among a plurality of display devices existing in the user's house. However, the technique described in Patent Document 1 has a problem that it is impossible to display the same content on both the user's display terminal and the display terminal of the other party while the user is talking on the phone.

Further, according to the technique described in Patent Document 2, it is possible to display the same content on the user's display terminal and the display terminal of the other party while the user is talking on the phone. However, the technique described in Patent Document 2 has a problem that, because there is a need to previously record an association between the user's SIP phone used by the user and the user's display terminal used in combination with the user's SIP phone into the user's home gateway (the user's HGW), the user cannot freely select a display terminal that the user uses with a call.

### SUMMARY

Accordingly, an object of the present invention is to provide a content display terminal selection system that solves the problem that it is impossible to, while a user is talking on the phone, display the same content on a display terminal selected by the user and a display terminal of the other party.

A content display terminal selection system according to the present invention includes:

a call information acquiring means for acquiring call session information for identifying a call established between a user's call terminal used for calling by a user and an operator's call terminal used for calling by an operator;

a content display terminal selecting means for selecting user's display terminals able to display content sent via a network from among a plurality of user's terminals existing in a user environment, displaying a list of the user's display terminals, and causing the user to select a user's display terminal used for displaying content by using the list; and

a session managing means for recording the call session information acquired by the call information acquiring means, terminal identification information showing the user's display terminal selected with the content display terminal selecting means, and terminal identification information showing an operator's display terminal previously associated with the operator's call terminal, in association with each other into a content share session information storage part, and transmitting same content when getting a WEB access from a user's display terminal and an operator's display terminal whose terminal identification information are recorded in association with same call session information.

A user call terminal according to the present invention is a user's call terminal as a component of a content display terminal selection system including: a call information acquiring means for acquiring call session information for identifying a call established between a user's call terminal used for calling by a user and an operator's call terminal used for calling the user's call terminal by an operator; and a session managing means for recording the call session information acquired by the call information acquiring means, terminal identification information showing a user's display terminal selected with a content display terminal selecting means, and terminal identification information showing an operator's display terminal previously associated with the operator's call terminal, in association with each other into a content share session information storage part, and transmitting same content when getting a WEB access from a user's display terminal and an operator's display terminal whose terminal identification information are recorded in association with same call session information,

the user's call terminal including the content display terminal selecting means for selecting user's display terminals able to display content sent via a network from among a plurality of user's terminals existing in a user environment, displaying a list of the user's display terminals, and causing the user to select a user's display terminal used for displaying content by using the list.

A server according to the present invention is a server as a component of a content display terminal selection system including: a call information acquiring means for acquiring call session information for identifying a call established between a user's call terminal used for calling by a user and an operator's call terminal used for calling by an operator; a content display terminal selecting means for selecting user's display terminals able to display content sent via a network from among a plurality of user's terminals existing in a user environment, displaying a list of the user's display terminals, and causing the user to select a user's display terminal used for displaying content by using the list; and the server,

the server including a session managing means for recording the call session information acquired by the call information acquiring means, terminal identification information showing the user's display terminal selected with the content display terminal selecting means, and terminal identification information showing an operator's display terminal previously associated with the operator's call terminal, in association with each other into a content share session information storage part, and transmitting same content when getting a WEB access from a user's display terminal and an operator's display terminal whose terminal identification information are recorded in association with same call session information.

A content display terminal selection method according to the present invention includes:

by a call information acquiring means, acquiring call session information for identifying a call established between a user's call terminal used for calling by a user and an operator's call terminal used for calling by an operator;

by a content display terminal selecting means, selecting user's display terminals able to display content sent via a network from among a plurality of user's terminals existing in a user environment, displaying a list of the user's display terminals, and causing the user to select a user's display terminal used for displaying content by using the list; and

by a session managing means, recording the call session information acquired by the call information acquiring means, terminal identification information showing the user's display terminal selected with the content display terminal selecting means, and terminal identification information showing an operator's display terminal previously associated with the operator's call terminal, in association with each other into a content share session information storage part, and transmitting same content when getting a WEB access from a user's display terminal and an operator's display terminal whose terminal identification information are recorded in association with same call session information.

A non-transitory computer-readable recording medium storing a program for a user's call terminal according to the present invention is a non-transitory computer-readable medium storing a program including instructions for causing a computer to realize a user's call terminal as a component of a content display terminal selection system comprising: a call information acquiring means for acquiring call session information for identifying a call established between a user's call terminal used for calling by a user and an operator's call terminal used for calling the user's call terminal by an operator; and a session managing means for recording the call session information acquired by the call information acquiring means, terminal identification information showing a user's display terminal selected with a content display terminal selecting means, and terminal identification information showing an operator's display terminal previously associated with the operator's call terminal, in association with each other into a content share session information storage part, and transmitting same content when getting a WEB access from a user's display terminal and an operator's display terminal whose terminal identification information are recorded in association with same call session information,

the program including instructions for causing the computer to function as the content display terminal selecting means for selecting user's display terminals able to display content sent via a network from among a plurality of user's terminals existing in a user environment, displaying a list of the user's display terminals, and causing the user to select a user's display terminal used for displaying content by using the list.

A non-transitory computer-readable recording medium storing a program for a server according to the present invention is a non-transitory computer-readable medium storing a program including instructions for causing a computer to realize a server as a component of a content display terminal selection system comprising: a call information acquiring means for acquiring call session information for identifying a call established between a user's call terminal used for calling by a user and an operator's call terminal used for calling by an operator; a content display terminal selecting means for selecting user's display terminals able to display content sent via a network from among a plurality of user's terminals existing in a user environment, displaying a list of the user's display terminals, and causing the user to select a user's display terminal used for displaying content by using the list; and the server,

the program including instructions for causing the computer to functions as a session managing means for recording the call session information acquired by the call information acquiring means, terminal identification information showing the user's display terminal selected with the content display terminal selecting means, and terminal identification information showing an operator's display terminal previously associated with the operator's call terminal, in association with each other into a content share session information storage part, and transmitting same content when getting a WEB access from a user's display terminal and an operator's display terminal whose terminal identification information are recorded in association with same call session information.

According to the present invention, it is possible to obtain an effect that a user can talk with an operator on the phone while causing a display terminal selected by him/her to display the same content as content displayed on a display terminal of the operator.

### BRIEF DESCRIPTION OF DRAWINGS

FIG. 1 is a block diagram showing a configuration example of a content display terminal selection system according to a first exemplary embodiment of the present invention;

FIG. 2 is a diagram showing a content example of a storage part 113;

FIG. 3 is a diagram showing a content example of a content share session information storage part 154;

FIG. 4 is a sequence diagram for describing an operation in the first exemplary embodiment;

FIG. 5 is a block diagram showing a specific configuration example in the first exemplary embodiment;

FIG. 6 is a diagram showing a display example of a display part 204;

FIG. 7 is a block diagram showing a configuration example of a content display terminal selection system according to a second exemplary embodiment of the present invention; and

FIG. 8 is a block diagram showing a configuration example of a content display terminal selection system according to a third exemplary embodiment of the present invention.

### EXEMPLARY EMBODIMENTS

Next, exemplary embodiments of the present invention will be described in detail referring to the drawings.

### First Exemplary Embodiment of the Present Invention

Referring to FIG. 1, a content display terminal selection system according to the present invention includes: a call terminal 100, a gateway terminal (may be referred to GW) 110, a support target terminal 120, and a display terminal 130, which are arranged in a user environment (e.g., in a user's house); a voice exchange server 140 and a service server 150, which are arranged in a server environment; and a gateway terminal 160, a call terminal 170, and a display terminal 180, which are arranged in an operator environment.

### [Configuration of Gateway Terminal 110]

The gateway terminal 110 includes a call information acquiring means 111, a terminal managing means 112, and a storage part 113. To the gateway terminal 110, the terminals 100, 120 and 130 existing in the user environment are connected.

In the storage part 113, terminal information of each of the terminals 100, 120 and 130 existing in the user environment is stored as shown in FIG. 2. As the terminal information, terminal identification information such as a name, model number, telephone number and IP address for uniquely identifying the terminal, a telephone number (an operator's telephone number) for asking the operator how to operate, how to deal with a trouble and the like on the phone, and image data of the terminal are recorded. In FIG. 2, the first, second and third records correspond to the terminals 100, 120 and 130, respectively. For example, the second record shows that the terminal identification information of the terminal 120 is “DVD recorder, . . . ,” the operator's telephone number of the terminal 120 is “YYYY,” and the image data of the terminal 120 is “G100.” The image data is used when a support terminal selecting means 102 and a content display terminal selecting means 103 in the call terminal 100 recognize a terminal existing in an image (a camera view) captured by a camera 105 as described later.

The call information acquiring means 111 has a function of, when a call between the call terminal 100 and another call terminal is established, generating call session information for identifying a call based on information exchanged between the call terminals, and notifying to the terminal managing means 112. Call session information includes the telephone numbers, IP addresses and so on of both a caller and a called party.

The terminal managing means 112 has the following functions.
A function of registering the terminal information of each of the terminals 100, 120 and 130 existing in the user environment into the storage part 113.
A function of transmitting the terminal information of each of the terminals 100, 120 and 130 registered in the storage part 113 to the support terminal selecting means 102 and the content display terminal selecting means 103.
A function of, when the telephone number of a called party included in call session information sent from the call information acquiring means 111 matches any of the operator telephone numbers recorded in the storage part 113, transmitting user's management information that includes the call session information, the terminal identification information of a support target terminal selected by the user and the terminal identification information of a display terminal selected by the user, to the service server 150.
A function of recording a history of connection to a network 190 of each of the terminals 100, 120 and 130 into the storage part 113. This connection history is used for determining whether each of the terminals 100, 120 and 130 can perform communication with an operator display terminal via the service server 150.

The gateway terminal 110 having the above functions can be realized by a computer and is realized by a computer in the following manner, for example: prepare a disk, a semiconductor memory or another recording medium on which a program for causing a computer to function as the call information acquiring means 111 and the terminal managing means 112 is recorded; and cause the computer to read the program. The computer controls its operation in accordance with the read program, thereby realizing the call information acquiring means 111 and the terminal managing means 112 on the computer itself.

### [Configuration of Call Terminal 100]

The call terminal 100, which is a mobile phone or the like, includes a voice call means 101, a support terminal selecting means 102, a content display terminal selecting means 103, a touchscreen-equipped display part 104, and the camera 105.

The voice call means 101 has a function of converting voice inputted through a transmitter into a voice packet and outputting to the network, a function of reproducing voice sent in the form of a voice packet and outputting from a receiver, a function of calling a telephone number passed by the support terminal selecting means 102, and so on.

The support terminal selecting means 102 is a means for letting the user select a terminal (a support target terminal) that the user wants to know how to operate or how to deal with a trouble from among the terminals existing in the user environment, and has the following functions.
A function of checking, for each of terminals existing in an image (a camera view) captured by the camera 105, whether terminal information of the terminal is recorded in the storage part 113 or not and, in a case where the terminal information of the terminal is recorded, displaying terminal identification information of the terminal in association with a terminal image of the terminal displayed on the display part 104.
A function of notifying a telephone number (an operator telephone number) included in terminal information of a terminal (the support target terminal 120) selected by the user touching the touchscreen to the voice call means 101, and causing it to automatically call the telephone number.

The content display terminal selecting means 103 has the following functions.
A function of checking, for each of terminals existing in an image captured by the camera 105, whether terminal information of the terminal is recorded in the storage part 113 or not and also checking whether the terminal has connected to the network 190 before or not and, in a case where the terminal information of the terminal is recorded and the terminal has a history of connection to the network 190, displaying terminal identification information of the terminal in association with a terminal image of the terminal displayed on the display part 104.
A function of transmitting terminal identification information of a terminal (the display terminal 130) selected by the user touching the touchscreen to the service server 150.

The voice call means 101, the support terminal selecting means 102 and the content display terminal selecting means 103 of the call terminal 100 can be realized by a CPU (Central Processing Unit), and are realized in the following manner: prepare a recording medium such as a disk on which a program for causing the CPU to function as the respective means 101, 102 and 103 is recorded; and cause the CPU to read the program. The CPU controls its operation in accordance with the read program, thereby realizing the respective means 101, 102 and 103 on the CPU itself.

### [Function of Voice Exchange Server]

The voice exchange server 140 has a function of exchanging voice packets, and is realized by a computer.

### [Configuration of Service Server 150]

The service server 150 includes a session managing means 151, a display content specifying means 152, and a storage part 153.

In the storage part 153, terminal identification information (the telephone number, IP address, and so on) of the call terminal 170 used by the operator, and terminal identification information (the IP address, and so on) of the display terminal 180 are previously recorded in association with each other. Moreover, in the storage part 153, a content share session information storage part 154 is provided as shown in FIG. 3. In the content share session information storage part 154, call session information for identifying a call established between a user call terminal (e.g., the call terminal 100) and an operator call terminal (e.g., the call terminal 170), terminal identification information of a display terminal (e.g., the display terminal 130) selected by the user with the content display terminal selecting means 103, WEB session information (including a session ID, etc.) for identifying WEB communication between the display terminal 130 and the service server 150, terminal identification information of the display terminal 180 used by the operator, and WEB session information for identifying WEB communication between the display terminal 180 and the service server 150 are recorded in association with each other. The information recorded in association with each other may also be referred to as content share session information.

The session managing means 151 has the following functions.
A function of, when user's management information is sent from the user's gateway terminal 110, passing the terminal identification information of the support target terminal 120 included in the user's management information to the display content specifying means 152, and causing to search for information (e.g., a content URL) about content to be displayed on the user's display terminal 130 and the operator's display terminal 180. Content to be searched for is content relating to the support target terminal 120 and is content in which how to operate, how to deal with a trouble and the like are written.
A function of, when user's management information is sent from the user's gateway terminal 110, recording call session information (information for identifying a call established between the call terminal 100 and another call terminal) included in the user's management information and the terminal identification information of the display terminal 130 in association with each other into the content share session information storage part 154 in the storage part 153. However, in a case where call session information identical to the above call session is already recorded, the terminal identification information of the display terminal 130 is recorded in association with the already recorded call session information.
A function of, when call session information for identifying a call established between the call terminal 170 and another call terminal is sent from the operator's gateway terminal 160, recording the call session information and the terminal identification information of the operator's display terminal 180 in association with each other into the content share session information storage part 154 in the storage part 153. However, in a case where call session information identical to the above call session information is already recorded, the terminal identification information of the display terminal 180 is recorded in association with the already recorded call session information. The terminal identification information of the display terminal 180 can be obtained by searching for terminal identification information of a display terminal recorded in association with the terminal identification information of the called party call terminal (the call terminal 170) in the call session information, from the terminal identification information of the display terminal recorded in the storage part 153.
A function of, when getting a HTTP access from a WEB browser on the user's display terminal 130, recording WEB session information (including a session ID generated at the time of the HTTP access from the WEB browser on the display terminal 130) for identifying WEB communication between the display terminal 130 and the service server 150 in association with the terminal identification information of the display terminal 130 already recorded in the content share session information storage part 154 in the storage part 153 and, after that, transmitting redirect information for redirecting to content with a URL passed from the display content specifying means 152, to the display terminal 130.
A function of, when getting a HTTP access from a WEB browser on the operator's display terminal 180, recording WEB session information (including a session ID generated at the time of the HTTP access from the WEB browser on the display terminal 180) for identifying WEB communication between the display terminal 180 and the service server 150 in association with the terminal identification information of the display terminal 180 already recorded in the content share session information storage part 154 in the storage part 153 and, after that, transmitting redirect information for redirecting to content with a URL passed from the display content specifying means 152, to the display terminal 180.
A function of, when a request for operation of content including WEB session information is sent from the WEB browser on the display terminal 130 or the display terminal 180, reflecting the request on both the display terminals 130 and 180.

The functions of the session managing means 151 are as described above.

The display content specifying means 152 searches a content storage part (not shown in the drawings) by using the terminal identification information of the support target terminal 120 included in the user's management information sent from the gateway terminal 110 as a key, and acquiring information of content relating to the support target terminal.

The service server 150 can be realized by a computer, and is realized in the following manner: prepare a recording medium such as a disk on which a program for causing a computer to function as the session managing means 151 and the display content specifying means 152 is recorded; and causing the computer to read the program. Consequently, the computer controls its operation and realizes the means 151 and the means 152 on the computer itself.

### [Configuration of Gateway Terminal 160]

The operator's gateway terminal 160 includes a call information acquiring means 161. Moreover, to the gateway terminal 160, the call terminal 170 and the display terminal 180 that are used by the operator are connected. The operator uses the combination of the communication terminal 170 and the display terminal 180 at all times to tell the user an apparatus operation method, and so on.

The call information acquiring means 161 has a function of, when a call between the call terminal 170 and another call terminal is established, generating call session information for identifying the call based on information exchanged between both the call terminals, and transmitting to the session managing means 151.

### Description of Operation in First Exemplary Embodiment

Next, referring to a sequence diagram shown in FIG. 4, an operation in this exemplary embodiment will be described in detail.

First, as a preparation for using the content display terminal selection system according to this exemplary embodiment, the terminal information of the respective terminals 100, 120 and 130 existing in the user environment are recorded into the storage part 113 (step S101). A method for recording the terminal information may be any method, and it is possible to employ a method that the user records by an input device such as a keyboard, a method that the terminal managing means 112 performs communication with the respective terminals to collect the terminal information and records the collected terminal information into the storage part 113, and so on. On the other hand, on the operator side, the terminal identification information of the call terminal 170 used by the operator and the terminal identification information of the display terminal 180 are recorded in association with each other into the storage part 153 (step S102).

After that, in a case where the user wants to ask the operator how to operate by using a remote support service, the user captures an image of the support target terminal 120 by the camera 105 mounted on the call terminal 100, and also starts the support terminal selecting means 102. Thus, the support terminal selecting means 102 requests the terminal managing means 112 to transmit the terminal information. Upon receiving this request, the terminal managing means 112 transmits the terminal information of the respective terminals 100, 120 and 130 recorded in the storage part 113 to the support terminal selecting means 102. For each of terminals existing in the image captured by the camera 105, the support terminal selecting means 102 checks whether terminal information of the terminal is recorded in the storage part 113 or not. In a case where the terminal information of the terminal is recorded, terminal identification information of the terminal is displayed in association with a terminal image of the terminal displayed on the display part 104. When the user touches the terminal identification information of the support target terminal (assumed to be the terminal 120), the support terminal selecting means 102 passes an operator telephone number included in the terminal information of the support target terminal 120 to the voice call means 101, and also passes the terminal identification information of the support target terminal 120 to the terminal managing means 112. Thus, the voice call means 101 calls the call terminal 170 with the telephone number passed from the support terminal selecting means. The terminal managing means 112 holds the terminal identification information of the support target terminal 120 (step S103).

The support terminal selecting means 102 checks whether the terminal information of the terminals existing in the image is recorded in the storage part 113 or not in the following manner. The support terminal selecting means 102 transmits a request for acquisition of the terminal information to the terminal managing means 112. Thus, the terminal managing means 112 transmits the terminal information of the respective terminals 100, 120 and 130 recorded in the storage part 113 to the support terminal selecting means 102. For each of terminal images existing in the image, the support terminal selecting means 102 compares image data of the terminal image with image data in the terminal information of each of the terminals 100, 120 and 130, thereby checking which terminal the terminal image is of. A method for selecting a support target terminal is not limited to the above. For example, each of terminals existing in the user environment is equipped with a RF tag in which terminal information of the terminal is recorded, and the call terminal 100 is equipped with a RF tag reading device, and the user selects a support target terminal by using the reading device to read the terminal information from the RF tag mounted on the support target terminal.

After that, when a call between the user call terminal 100 and the operator call terminal 170 is established, the operator's call information acquiring means 161 acquires call session information for identifying the call based on information exchanged between the terminals 100 and 170, and passes to the session managing means 151. Thus, the session managing means 151 records the above call session information and the terminal identification information of the operator's display terminal 180 in association with each other into the content share session information storage part 154 (step S106-2, see FIG. 3).

After starting the call to the operator, the user selects the display terminal 130 to be used for displaying content from among the terminals existing in the user environment (step S105). To be specific, the user captures images of terminals existing around the support target terminal 120 with the camera 105, and starts the content display terminal selecting means 103. Thus, the content display terminal selecting means 103 requests the terminal managing means 112 to transmit the terminal information of the respective terminals 100, 120 and 130 and a history of connection to the network 190. The terminal managing means 112 transmits the requested information to the content display terminal selecting means 103. For each of the terminals existing in the image captured by the camera 105, the content display terminal selecting means 103 checks whether terminal information of the terminal is recorded in the storage part 113 or not, and also checks whether the terminal has connected to the network 109 before or not. In a case where the terminal information of the terminal is recorded in the storage part 113 and the terminal has connected to the network 190 before, terminal identification information of the terminal is displayed in association with a terminal image of the terminal displayed on the display part 104. When the user touches terminal identification information of a terminal to be used for displaying content (the display terminal 130), the content display terminal selecting means 103 passes terminal identification information of the display terminal 130 to the terminal managing means 112.

Thus, the terminal managing means 112 passes user's management information that includes the call session information passed from the call information acquiring means 111, the terminal identification information of the support target terminal held thereby passed from the support terminal selecting means 102 and the terminal identification information of the display terminal 130 passed from the content display terminal selecting means 103, to the session managing means 151 in the service server 150. The above call session information (the call session information for identifying the call between the call terminal 100 and the call terminal 170; see FIG. 3) is already recorded in the content share session information storage part 154, the session managing means 151 records the terminal identification information of the user's display terminal in association with the above call session information (step S106-1).

The session managing means 151 passes the terminal identification information of the support target terminal 120 included by the user's management information, to the display content specifying means 152. The display content specifying means 152 searches the content storage part (not shown in the drawings) by using the terminal identification information of the support target terminal 120 as a key to acquire content relating to the support target terminal 120, and passes the URL of the content to the session managing means 151. Upon receiving the URL of the content from the display content specifying means 152, the session managing means 151 holds the URL and the call session information included by the user's management information in association with each other (step S107).

After that, upon getting a HTTP access by a WEB browser from the user's display terminal 130, the session managing means 151 generates WEB session information for identifying WEB communication with the display terminal 130, and records the WEB session information for identifying the WEB communication with the display terminal 130 in association with the terminal identification information of the user's display terminal 130 already recorded in the content share session information storage part 154 (see FIG. 3). Moreover, the session managing means 151 transmits the WEB session information to the display terminal 130 (step S108-1, S109). In the case of receiving a HTTP access from the operator's display terminal 180, the session managing means 151 records WEB session information for identifying a WEB communication with the display terminal 180 in association with the terminal identification information of the operator's display terminal 180 already recorded in the content share session information storage part 154, and also transmits the WEB session information to the display terminal 180 (step S108-2, S109).

After that, the session managing means 151 transmits redirect information for redirecting to the content relating to the support target terminal 120 acquired in step S107, to the display terminals 130 and 180 (step S110). To be more specific, in the case of getting a HTTP access from the user's display terminal 130, the session managing means 151 searches the content share session information storage part 154 for call session information (call session information for the display terminal 130 and the display terminal 180) recorded in association with the terminal identification information of the display terminal 130, and searches for a URL held in association with the call session information from among the held content URLs. After that, the session managing means 151 transmits redirect information including the searched-out URL to the display terminal 130. Also when getting a HTTP access from the operator's display terminal 180, the session managing means 151 executes the same process.

Both the user's display terminal 130 and the operator's display terminal 180 redirect in accordance with the redirect information and display the content relating to the support target terminal 120. Moreover, after the content is displayed, in a case where an operation of the content is executed on one of the display terminals, the session managing means 151 causes the same operation to be executed on the other display terminal. For example, in a case where an operation for displaying the next page (the second page) is executed on the operator's display terminal 180, the display terminal 180 transmits WEB session information for identifying WEB communication between the display terminal 180 and the service server 150, and an operation request including the URL of the next page, to the service server 150. Thus, the session managing means 151 transmits content shown with the above URL to the display terminal 180. Moreover, the session managing means 151 searches the content share session information storage part 154 for the terminal identification information of the user's display terminal 130 recorded in association with the above WEB session information, and transmits the content shown with the above URL to the display terminal 130 specified by this terminal identification information. Consequently, the second page of the content is displayed on both the user's display terminal 130 and the operator's display terminal 180 (step S111).

After that, when the user or the operator hangs up, the call session between the call terminal 100 and the call terminal 170 is disconnected (step S112), and the call information acquiring means 111 or the call information acquiring means 161 transmits call session end information to the session managing means 151 (step S113).

The session managing means 151 discards the content share session information that manages a linkage between the combination of the call terminal 100 and the display terminal 130 and the combination of the call terminal 170 and the display terminal 180, and releases a linkage between the call session and the WEB communication session (step S114).

Finally, the session managing means 151 notifies release of the session linkage to the display terminal 130 and the display terminal 180, and ends display of the content (step S115).

Although not described in the exemplary embodiment described above, the system may be configured to previously include the outer sizes of the terminals 100, 120 and 130 (e.g., a longer one of the outer length and the outer width of the terminal) into the terminal information of the terminals 100, 120 and 130 recorded in the storage part 113 and, when selecting a display terminal for displaying content with the content display terminal selecting means 103, calculate distances from the camera 105 to the respective terminals by using the above outer sizes and clearly display the terminal identification information of a display terminal with the shortest distance (a display terminal that is the nearest from the user). To be specific, the terminal identification information of a display terminal with the shortest distance from the user is displayed with an eye-catching color or with letters of an increased size. The distance from the camera 105 to the terminal can be obtained by the following equation, for example.

Distance=(outer size of terminal as distance measurement target)÷(number of pixels on screen of outer size portion)×(focal length of camera 105)

### Example

Next, the first exemplary embodiment will be described with a specific example.

An example of the present invention is a content display terminal selection system in remote support based on the first exemplary embodiment.

As shown in FIG. 5, a user environment such as a user's house contains a smartphone 200, a home gateway terminal (HGW) 210, a DVD recorder 220, a TV 230, a laptop PC 231, and a telephone fax machine 232. A server environment contains a SIP server 240 and a service server 250. An operator environment contains a gateway terminal (GW) 260, a SIP telephone 270, and a PC 280.

The smartphone 200 used by the user includes a voice call program 201, a support terminal selection program 202, a content display terminal selection program 203, a touchscreen display part 204, and a camera 205.

The HGW 210 is configured by a call information acquisition program 211 and a terminal management program 212.

The TV 230, the laptop PC 231 and the telephone fax machine 232 each include a display, and an input device such as a keyboard and push-buttons.

The service server 250 is configured by a session management program 251 and a display content specification program 252.

The GW 260 includes a call information acquisition program 261.

The GW 210 is connected with the SIP server 240, the service server 250 and the GW 260 via an internet 290.

The SIP telephone 270 has an equivalent function to that of the voice call program 201.

The respective programs are stored in hard disks (not shown in the drawings) that the smartphone 200, the HGW 210, the service server 250 and the GW 260 include and, when necessary, transferred to memories (not shown in the drawings) that the respective terminals include and executed by CPUs (not shown in the drawings). The touchscreen display part 204 of the smartphone 200 includes a content display function and a user operation input function, and data is transmitted and received between the touchscreen display part 204 and the respective programs.

The terminals existing in the user environment are connected to the HGW 210 via a home network. The HGW 210 is connected to the SIP server 240, the service server 250 and the GW 260 via the Internet 290. The SIP telephone 270 and the PC 280 are connected to the GW 260 via a local area network in the operator environment.

As shown in FIG. 6, a DVD recorder, a TV, a laptop PC and a telephone fax machine are in a room where the user is present. Herein, a case where the DVD recorder breaks down and the user gets a remote support service is supposed.

It is assumed that terminal information (terminal identification information such as the names and the model numbers, the telephone numbers of support centers, and image data of terminals) of the smartphone 200, the DVD recorder 220, the TV 230, the laptop PC 231 and the telephone fax machine 232 are registered in the terminal management program 212. Moreover, it is assumed that the TV 230, the laptop PC 231 and the telephone fax machine 232 have been connected to the network 290 with WEB browsers included thereby, respectively, and connection histories are recorded in the terminal management program 212. In the session management program 251, terminal information of the SIP telephone 270 and terminal information of the PC 280 (the telephone number of the SIP telephone 270, and the IP addresses of the telephone 270 and the PC 280) are recorded in association with each other.

When the user displays the inside of the room as shown by FIG. 6 in a camera view of the smartphone 200, the support terminal selection program 202 recognizes the camera view, and displays the terminal information managed by the terminal management program 212 near the respective terminal images. For example, the support terminal selection program 202 displays the names of the terminals as shown by FIG. 6.

When the user executes a selection operation by touching on the name of the faulty DVD recorder 220, the support terminal selection program 202 detects that the DVD recorder 220 is selected, and passes the telephone number of the support center included in the terminal information of the DVD recorder 220 to the voice call program 201. The voice call program 201 automatically calls the SIP telephone 270 of the operator. Consequently, a call session via the SIP server 240 is established, and a call between the smartphone 200 and the SIP telephone 270 is started.

Next, the content display terminal selection program 203 extracts the terminal information of the terminals having the histories of connection to the network 290, from among the terminal information registered in the terminal management program 212. After that, the content display terminal selection program 203 displays the extracted terminal information in the vicinity of the corresponding terminal image. For example, the support terminal selection program 202 displays the names of the terminals as shown by FIG. 6.

When the user executes a selection operation by touching on the name of the TV 230 located near the DVD recorder 220, the content display terminal selection program 203 detects selection of the TV 230 and notifies it to the terminal management program 212. The terminal management program 212 transmits the terminal identification information of the DVD recorder as a support target terminal, the terminal identification information of the TV 230 as a content display terminal, and call session information for identifying the call between the smartphone 200 and the SIP telephone 270 acquired by the call information acquisition program 211, to the service server 250.

In the GW 260, the call information acquisition program 261 acquires the call session information for identifying the call between the smartphone 200 and the SIP telephone 270, and transmits the call session information to the session management program 251.

The session management program 251 passes the model number of the DVD recorder 220 included in the terminal identification information received from the terminal management program 212, to the display content specification program, acquires a manual relating to the DVD recorder 220 by using the model number as a key, and passes the manual to the session management program 251.

Upon accepting an access with a WEB browser from the TV 230 or the PC 280, the session management program 251 stores the call session information of the call between the user and the operator, WEB session information of WEB communication between the service server and the PC, WEB session information of WEB communication between the service server and the TV, the terminal identification information of the TV 230, and the terminal identification information of the PC 280 in association with each other. When the call session information of the smartphone 200 and the SIP telephone 270 match, the session management program 251 associates the WEB session information so that the TV 230 and the PC 280 can share content. WEB session information is information generated at the time of an access with a WEB browser.

The session management program 251 transmits information for redirecting to content relating to the DVD recorder as a support target terminal, to the TV 230 and the PC 280. Upon receiving the redirect information from the session management program 251, the WEB browser of the TV 230 or the PC 280 operates so as to redirect to the designated content, and receives the manual and information about an operation on the displayed manual. An operation on a manual is drawing a stroke so as to overlap a display region of the manual, or changing the display region of the manual.

When the user or the operator hands up, the call session between the smartphone 200 and the SIP telephone 270 is disconnected, and the call information acquisition program 211 or the call information acquisition program 261 transmits call session end information to the session management program 251. The session management program 251 discards content share session information that manages a linkage between the combination of the smartphone 200 and the TV 230 and the combination of the SIP telephone 270 and the PC 280, and releases a linkage between the call session and the content share session. Finally, it is notified to the TV 230 and the PC 280 that the session management program 251 has released the session linkage, and display of the content is ended.

As described above, only by capturing a photograph including a support target user terminal, it is possible to cause another terminal located near the support target user terminal to display a manual or the like, and it is possible to increase the depth of understanding of an operator's instruction. Moreover, it is possible to freely select a display terminal (a terminal for displaying a manual) to be used in combination with a call terminal depending on the placement location of the support target user terminal.

### Effect of First Exemplary Embodiment

According to this exemplary embodiment, it is possible to obtain an effect that a user can talk with an operator on the phone in a state that a display terminal selected by him/her displays the same content as the display terminal of the operator. This is because the terminal identification information of the display terminal 130 selected by the user with the content display terminal selecting means 103 and the terminal identification information of the operator display terminal 180 are recorded in association with call session information for identifying a call between the user call terminal 100 and the operator call terminal 170 and, at the time of a WEB access, the same content is transmitted to the user's display terminal 130 and the operator's display terminal 180 whose terminal identification information are recorded in association with the same call session information.

Further, according to this exemplary embodiment, it is possible to cause a user's display terminal and an operator's display terminal to display content relating to a support target terminal that the user wants to ask the operator how to use. This is because the system includes the display content specifying means 152 that selects content relating to the support target terminal 120 selected by the user with the support terminal selecting means 102 and manages content identification information of the content in association with call session information.

Further, according to the present invention, an operation on content performed on either a user's display terminal or an operator's display terminal can be reflected on content displayed on the other terminal. This is because the system is configured to, in association with call session information of a call between the user call terminal 100 and the operator call terminal 170, record the terminal identification information of the user's display terminal 130 and WEB session information, and also record the terminal identification information of the operator's display terminal 180 and WEB session information.

Further, according to the present invention, a terminal image of a display terminal and terminal identification information thereof are displayed in association with each other by the display part 104, and it is possible by selecting the displayed terminal identification information to select the display terminal 130 to be used for displaying content, so that the user can easily select a display terminal to be used for displaying content.

Further, according to the present invention, it is possible to differentiate a display mode of terminal identification information of a display terminal whose distance from the camera 105 is the shortest, from a display mode of the other terminal identification information among the terminal identification information displayed on the display part 104, so that the user can easily select a display terminal that is the nearest from him/her.

### Second Exemplary Embodiment of the Present Invention

Next, a content display terminal selection system according to a second exemplary embodiment of the present invention will be described.

Referring to FIG. 7, the content display terminal selection system of this exemplary embodiment is different from that of the first exemplary embodiment shown by FIG. 1 in including a gateway terminal 110a instead of the gateway terminal 110 and including a service server 150a instead of the service server 150.

The gateway terminal 110a is different from the gateway terminal 110 of the first exemplary embodiment in including a display content specifying means 114. The display content specifying means 114 has the same function as the display content specifying means 152 of the first exemplary embodiment.

The service server 150a is different from the service server 150 of the first exemplary embodiment in including a terminal managing means 155 and not including the display content specifying means 152.

### Description of Operation of Second Exemplary Embodiment

Next, an operation of the content display terminal selection system according to the second exemplary embodiment according to the present invention will be described. Below, the differences from the first exemplary embodiment will be chiefly described.

Although the terminal managing means 112 in the gateway terminal 110 of the first exemplary embodiment temporarily holds terminal identification information of a support target terminal sent from the support terminal selecting means 102 in step S103 shown in FIG. 4, the terminal managing means 112 in the gateway terminal 110a of this exemplary embodiment immediately passes terminal identification information of a support target terminal sent from the support terminal selecting means 102 to the display content specifying means 114. Moreover, upon receiving terminal identification information of the display terminal 130 sent from the content display terminal selecting means 103, the terminal managing means 112 in the first exemplary embodiment transmits user's management information that includes call session information passed by the call information acquiring means 111, terminal identification information of the support target terminal 120 temporarily held thereby and terminal identification information of the display terminal 130 to the session managing means 151, but the terminal managing means 112 in this exemplary embodiment transmits user's management information that includes the call session information and the terminal identification information of the display terminal 130 and does not include the terminal identification information of the support target terminal 120 to the session managing means 151.

The display content specifying means 114 searches a content storage part (not shown in the drawings) provided in the gateway terminal 110a for content relating to the support target terminal 120. After that, when the terminal identification information of the display terminal 130 is sent from the content display terminal selecting means 103, the display content specifying means 114 transmits the user's management information including the call session information and the terminal identification information of the display terminal 130 and the searched-out content to the session managing means 151. The session managing means 151 records the sent content into a content storage part (not shown in the drawings) in the own server 150a to hold a URL showing where the content is and the call session information in the user's management information in association with each other. An operation when there is a HTTP access from the display terminal 130 and the display terminal 180 after that is the same as in the first exemplary embodiment.

The terminal managing means 155 of the service server 150a collects terminal information (including terminal identification information, operator telephone numbers, and image data of the terminals) shared on the network 190, and records into the storage part 153.

In a case where an image captured by the camera 105 contains a terminal whose terminal information is not recorded in the storage part 113, the support terminal selecting means 102 and the content display terminal selecting means 103 send image data of the image to the terminal managing means 155 of the service server 150a. Thus, the terminal managing means 155 searches for terminal information of the terminal shown in the image from among the terminal information recorded in the storage part 153. In a case where the corresponding terminal information is searched out, the terminal managing means 155 returns the searched-out terminal information to the terminal managing means 112. In a case where the corresponding terminal information is not searched out, the terminal managing means 155 notifies that. The terminal managing means 112 again executes the same processes as in step S103 and step S105 described before by using the terminal information sent from the service server 150a and the terminal information recorded in the storage part 113.

### Effect of Second Exemplary Embodiment

In this exemplary embodiment, in a case where content relating to the support target terminal 120 is not present in the service server or on the network because the support expiration has passed, it is possible to execute a remote support by using content stored in the gateway terminal 110. Moreover, it is also possible to realize a self-help function by loading and displaying content such as a manual in the gateway terminal 110 onto the call terminal 100 when the support target terminal 120 is selected by the support terminal selecting means 102. Besides, because the service server 150a includes the terminal managing means 155, the user can acquire terminal information unregistered in the gateway terminal 110.

### Third Exemplary Embodiment of the Present Invention

Next, a content display terminal selection system according to a third exemplary embodiment of the present invention will be described referring to FIG. 8.

A content display terminal selection system according to this exemplary embodiment includes a call information acquiring means 301, a content display terminal selecting means 302, and a session managing means 303.

The call information acquiring means 301 acquires call session information for identifying a call established between a user's call terminal 304 used for calling by a user and an operator's call terminal 305 used for calling by an operator.

The content display terminal selecting means 302 selects user's display terminals able to display content sent via a network from among a plurality of user's terminals existing in a user environment, displays a list of the user's display terminals, and causes the user to select a user's display terminal used for displaying content by using the list.

The session managing means 303 records the call session information 307 acquired by the call information acquiring means 301, terminal identification information 308 showing the user's display terminal selected with the content display terminal selecting means 302, and terminal identification information 309 showing an operator's display terminal previously associated with the operator's call terminal 305, in association with each other into a content share session information storage part 306, and transmits same content when getting a WEB access from a user's display terminal and an operator's display terminal whose terminal identification information are recorded in association with same call session information.

According to this, the user can talk with the operator on the phone while causing a display terminal selected by the user (the user's display terminal) to display the same content as displayed on a display terminal of the operator (the operator's display terminal). This is because the system is configured to record the terminal identification information 308 of the user's display terminal selected by the user with the content display terminal selecting means 302 and the terminal identification information 309 of the operator's display terminal in association with the call session information 307 for identifying the call between the user call terminal 304 and the operator call terminal 305 and, at the time of a WEB access, transmit the same content to the user's display terminal and the operator's display terminal whose terminal identification information are recorded in association with the same call session information.

Further, the content display terminal selection system includes: a support terminal selecting means for causing the user to select a support target terminal to be a target of support from among the plurality of user's terminals; and a display content specifying means for selecting content relating to the support target terminal selected with the support terminal selecting means, and managing content identification information showing the selected content and the call session information acquired by the call information acquiring means 301 in association with each other. The session managing means 303 is configured to, when getting a WEB access from a user's display terminal and an operator's display terminal whose terminal identification information are recorded in association with same call session information, transmit the content shown by the content identification information managed by the display content specifying means in association with the call session information.

According to this, it is possible to cause the user's display terminal and the operator's display terminal to display content relating to a support target terminal that the user wants to ask the operator how to use or the like. This is because the display content specifying means selects content relating to a support target terminal selected by the user with the support terminal selecting means, and manages content identification information of the content in association with call session information.

Further, the session managing means is configured to: when getting a WEB access from a user's display terminal, transmit WEB session information for identifying WEB communication with the user's display terminal to the user's display terminal, and also record the WEB session information in association with the terminal identification information of the user's display terminal recorded in the content share session information storage part 306; when getting a WEB access from an operator's display terminal, transmit WEB session information for identifying WEB communication with the operator's display terminal to the operator's display terminal, and also record the WEB session information in association with the terminal identification information of the operator's display terminal recorded in the content share session information storage part 306; and when getting a content operation request including the WEB session information from one of the user's display terminal and the operator's display terminal, executing an operation requested in the operation request on the one display terminal, and also searching the content share session information storage part 306 for terminal identification information recorded in association with the WEB session information included in the operation request and executing the operation requested in the operation request on a display terminal specified based on the searched-out terminal identification information.

According to this, it is possible to reflect an operation on content performed on either the user's display terminal or the operator's display terminal, on content displayed on the other display terminal. This is because the system is configured to, in association with call session information for identifying a call between the user's call terminal 304 and the operator's call terminal 305, record the terminal identification information of the user's display terminal and WEB session information and also record the terminal identification information of the operator's display terminal and the WEB session information. In other words, it is possible to specify a display terminal of the other party based on WEB session information in an operation request.

Further, the user's call terminal 304 includes a camera for imaging the plurality of user terminals, and a display part displaying an image captured by the camera; and the content display terminal selecting means 302 is configured to, in association with terminal images of user's display terminals able to display content sent via a network among terminal images of user's terminals existing in an image displayed by the display part, display terminal identification information of the user's display terminals, and causing the user to select a user's display terminal to be used for displaying content from among the user's display terminals shown by the displayed terminal identification information.

According to this, terminal images of display terminals and terminal identification information of the display terminals are displayed in association with each other on the display part, and it is possible, by selecting the displayed terminal identification information, select a display terminal to be used for displaying content, so that the user can easily select a terminal device to be used for displaying content.

Further, the content display terminal selecting means is configured to differentiate a display mode of terminal identification information of a user's display terminal having a shortest distance from the camera among the terminal identification information displayed by the display part, from a display mode of the other terminal identification information.

According to this, it is possible to differentiate a display mode of terminal identification information of a display terminal whose distance from the camera is the shortest among the terminal identification information displayed on the display part, from a display mode of the other terminal identification information, so that the user can easily select a display terminal that is the nearest from the user.

A user's call terminal 304 as another aspect of the present invention is a component of a content display terminal selection system including: a call information acquiring means 301 for acquiring call session information for identifying a call established between the user's call terminal 304 and an operator's call terminal 305; and a session managing means 303 for recording the call session information 307 acquired by the call information acquiring means 301, terminal identification information showing a user's display terminal selected with a content display terminal selecting means 302, and terminal identification information showing an operator's display terminal previously associated with the operator's call terminal 305, in association with each other into a content share session information storage part 306, and transmitting same content when getting a WEB access from a user's display terminal and an operator's display terminal whose terminal identification information are recorded in association with same call session information. The user's call terminal includes the content display terminal selecting means for selecting user's display terminals able to display content sent via a network from among a plurality of user's terminals existing in a user environment, displaying a list of the user's display terminals, and causing the user to select a user's display terminal used for displaying content by using the list.

A server as another aspect of the present invention is a component of a content display terminal selection system including: a call information acquiring means 301 for acquiring call session information for identifying a call established between a user's call terminal 304 used for calling by a user and an operator's call terminal 305 used for calling by an operator; a content display terminal selecting means 302 for selecting user's display terminals able to display content sent via a network from among a plurality of user's terminals existing in a user environment, displaying a list of the user's display terminals, and causing the user to select a user's display terminal used for displaying content by using the list; and the server. The server includes a session managing means for recording the call session information 307 acquired by the call information acquiring means 301, terminal identification information 308 showing the user's display terminal selected with the content display terminal selecting means 302, and terminal identification information 309 showing an operator's display terminal previously associated with the operator's call terminal 305, in association with each other into a content share session information storage part 306, and transmitting same content when getting a WEB access from a user's display terminal and an operator's display terminal whose terminal identification information are recorded in association with same call session information.

Further, a content display terminal selection method as another aspect of the present invention includes:

by a call information acquiring means 301, acquiring call session information for identifying a call established between a user's call terminal 304 used for calling by a user and an operator's call terminal 305 used for calling by an operator;

by a content display terminal selecting means 302, selecting user's display terminals able to display content sent via a network from among a plurality of user's terminals existing in a user environment, displaying a list of the user's display terminals, and causing the user to select a user's display terminal used for displaying content by using the list; and

by a session managing means 303, recording the call session information 307 acquired by the call information acquiring means 301, terminal identification information 308 showing the user's display terminal selected with the content display terminal selecting means 302, and terminal identification information 309 showing an operator's display terminal previously associated with the operator's call terminal 305, in association with each other into a content share session information storage part 306, and transmitting same content when getting a WEB access from a user's display terminal and an operator's display terminal whose terminal identification information are recorded in association with same call session information.

A recording medium as another aspect of the present invention is a non-transitory computer-readable medium storing a program including instructions for causing a computer to realize a user's call terminal as a component of a content display terminal selection system including: a call information acquiring means 301 for acquiring call session information for identifying a call established between a user's call terminal 304 used for calling by a user and an operator's call terminal 305 used for calling the user's call terminal 304 by an operator; and a session managing means 303 for recording the call session information 307 acquired by the call information acquiring means 301, terminal identification information 308 showing a user's display terminal selected with a content display terminal selecting means 302, and terminal identification information 309 showing an operator's display terminal previously associated with the operator's call terminal, in association with each other into a content share session information storage part 306, and transmitting same content when getting a WEB access from a user's display terminal and an operator's display terminal whose terminal identification information are recorded in association with same call session information. The program recorded on the recording medium includes instructions for causing the computer to function as the content display terminal selecting means for selecting user's display terminals able to display content sent via a network from among a plurality of user's terminals existing in a user environment, displaying a list of the user's display terminals, and causing the user to select a user's display terminal used for displaying content by using the list.

A recording medium according to the present invention is a non-transitory computer-readable medium storing a program including instructions for causing a computer to realize a server as a component of a content display terminal selection system including: a call information acquiring means 301 for acquiring call session information for identifying a call established between a user's call terminal 304 used for calling by a user and an operator's call terminal 305 used for calling by an operator; a content display terminal selecting means 302 for selecting user's display terminals able to display content sent via a network from among a plurality of user's terminals existing in a user environment, displaying a list of the user's display terminals, and causing the user to select a user's display terminal used for displaying content by using the list; and the server. The program recorded on the recording medium includes instructions for causing the computer to function as a session managing means 303 for recording the call session information 307 acquired by the call information acquiring means 301, terminal identification information 308 showing the user's display terminal selected with the content display terminal selecting means 302, and terminal identification information 309 showing an operator's display terminal previously associated with the operator's call terminal 305, in association with each other into a content share session information storage part, and transmitting same content when getting a WEB access from a user's display terminal and an operator's display terminal whose terminal identification information are recorded in association with same call session information.

Although the present invention is described above referring to the respective exemplary embodiments described above, the present invention is not limited to the exemplary embodiments. The configurations and details of the present invention can be modified in various manners that can be understood by one skilled in the art within the scope of the present invention

The present invention is based upon and claims the benefit of priority from Japanese patent application No. 2011-244700, filed on Nov. 8, 2011, the disclosure of which is incorporated herein in its entirety by reference.

### INDUSTRIAL APPLICABILITY

The present invention can be applied to a remote support using a network.

### DESCRIPTION OF REFERENCE NUMERALS

100 call terminal
101 voice call means
102 support terminal selecting means
103 content display terminal selecting means
104 display part
105 camera
109 network
110 gateway terminal
110a gateway terminal
111 call information acquiring means
112 terminal managing means
113 storage part
114 display content specifying means
120 support target terminal
130 display terminal
140 voice exchange server
150 service server
150a service server
151 session managing means
152 display content specifying means
153 storage part
154 content share session information storage part
155 terminal managing means
160 gateway terminal
161 call information acquiring means
170 call terminal
180 display terminal
190 network
200 smartphone
201 voice call program
202 support terminal selection program
203 content display terminal selection program
204 display part
210 home gateway terminal
211 call information acquisition program
212 terminal management program
220 DVD recorder
230 TV
231 laptop PC
232 telephone fax machine
240 SIP server
250 service server
251 session management program
252 display content specification program
260 gateway terminal
261 call information acquisition program
270 SIP telephone
280 PC
290 Internet
301 call information acquiring means
302 content display terminal selecting means
303 session managing means
304 user call terminal
305 operator call terminal
306 content share session information storing part

1. A content display terminal selection system comprising:
a call information acquiring unit for acquiring call session information for identifying a call established between a user's call terminal used for calling by a user and an operator's call terminal used for calling by an operator;
a content display terminal selecting unit for selecting user's display terminals able to display content sent via a network from among a plurality of user's terminals existing in a user environment, displaying a list of the user's display terminals, and causing the user to select a user's display terminal used for displaying content by using the list; and
a session managing unit for recording the call session information acquired by the call information acquiring unit, terminal identification information showing the user's display terminal selected with the content display terminal selecting unit, and terminal identification information showing an operator's display terminal previously associated with the operator's call terminal, in association with each other into a content share session information storage part, and transmitting same content when getting a WEB access from a user's display terminal and an operator's display terminal whose terminal identification information are recorded in association with same call session information.

2. The content display terminal selection system according to claim 1, comprising:
a support terminal selecting unit for causing the user to select a support target terminal to be a target of support from among the plurality of user's terminals; and
a display content specifying unit for selecting content relating to the support target terminal selected with the support terminal selecting unit, and managing content identification information showing the selected content and the call session information acquired by the call information acquiring unit in association with each other,
wherein the session managing unit is configured to, when getting a WEB access from a user's display terminal and an operator's display terminal whose terminal identification information are recorded in association with same call session information, transmit the content shown by the content identification information managed by the display content specifying unit in association with the call session information.

3. The content display terminal selection system according to claim 1, wherein the session managing unit is configured to: when getting a WEB access from a user's display terminal, transmit WEB session information for identifying WEB communication with the user's display terminal to the user's display terminal, and also record the WEB session information in association with the terminal identification information of the user's display terminal recorded in the content share session information storage part; when getting a WEB access from an operator's display terminal, transmit WEB session information for identifying WEB communication with the operator's display terminal to the operator's display terminal, and also record the WEB session information in association with the terminal identification information of the operator's display terminal recorded in the content share session information storage part; and when getting a content operation request including the WEB session information from one of the user's display terminal and the operator's display terminal, executing an operation requested in the operation request on the one display terminal, and also searching the content share session information storage part for terminal identification information recorded in association with the WEB session information included in the operation request and executing the operation requested in the operation request on a display terminal specified based on the searched-out terminal identification information.

4. The content display terminal selection system according to claim 1, wherein:
the user's call terminal includes a camera for imaging the plurality of user terminals, and a display part displaying an image captured by the camera; and
the content display terminal selecting unit is configured to, in association with terminal images of user's display terminals able to display content sent via a network among terminal images of user's terminals existing in an image displayed by the display part, display terminal identification information of the user's display terminals, and causing the user to select a user's display terminal to be used for displaying content from among the user's display terminals shown by the displayed terminal identification information.

5. The content display terminal selection system according to claim 4, wherein the content display terminal selecting unit is configured to differentiate a display mode of terminal identification information of a user's display terminal having a shortest distance from the camera among the terminal identification information displayed by the display part, from a display mode of the other terminal identification information.

6. A user's call terminal as a component of a content display terminal selection system comprising: a call information acquiring unit for acquiring call session information for identifying a call established between a user's call terminal used for calling by a user and an operator's call terminal used for calling the user's call terminal by an operator; and a session managing unit for recording the call session information acquired by the call information acquiring unit, terminal identification information showing a user's display terminal selected with a content display terminal selecting unit, and terminal identification information showing an operator's display terminal previously associated with the operator's call terminal, in association with each other into a content share session information storage part, and transmitting same content when getting a WEB access from a user's display terminal and an operator's display terminal whose terminal identification information are recorded in association with same call session information,
the user's call terminal comprising the content display terminal selecting unit for selecting user's display terminals able to display content sent via a network from among a plurality of user's terminals existing in a user environment, displaying a list of the user's display terminals, and causing the user to select a user's display terminal used for displaying content by using the list.

7. A server as a component of a content display terminal selection system comprising: a call information acquiring unit for acquiring call session information for identifying a call established between a user's call terminal used for calling by a user and an operator's call terminal used for calling by an operator; a content display terminal selecting unit for selecting user's display terminals able to display content sent via a network from among a plurality of user's terminals existing in a user environment, displaying a list of the user's display terminals, and causing the user to select a user's display terminal used for displaying content by using the list; and a server,
the server comprising a session managing unit for recording the call session information acquired by the call information acquiring unit, terminal identification information showing the user's display terminal selected with the content display terminal selecting unit, and terminal identification information showing an operator's display terminal previously associated with the operator's call terminal, in association with each other into a content share session information storage part, and transmitting same content when getting a WEB access from a user's display terminal and an operator's display terminal whose terminal identification information are recorded in association with same call session information.

8. A content display terminal selection method comprising:
by a call information acquiring unit, acquiring call session information for identifying a call established between a user's call terminal used for calling by a user and an operator's call terminal used for calling by an operator;
by a content display terminal selecting unit, selecting user's display terminals able to display content sent via a network from among a plurality of user's terminals existing in a user environment, displaying a list of the user's display terminals, and causing the user to select a user's display terminal used for displaying content by using the list; and
by a session managing unit recording the call session information acquired by the call information acquiring unit, terminal identification information showing the user's display terminal selected with the content display terminal selecting unit, and terminal identification information showing an operator's display terminal previously associated with the operator's call terminal, in association with each other into a content share session information storage part, and transmitting same content when getting a WEB access from a user's display terminal and an operator's display terminal whose terminal identification information are recorded in association with same call session information.

9. A non-transitory computer-readable medium storing a program comprising instructions for causing a computer to realize a user's call terminal as a component of a content display terminal selection system comprising: a call information acquiring unit for acquiring call session information for identifying a call established between a user's call terminal used for calling by a user and an operator's call terminal used for calling the user's call terminal by an operator; and a session managing unit for recording the call session information acquired by the call information acquiring unit, terminal identification information showing a user's display terminal selected with a content display terminal selecting unit, and terminal identification information showing an operator's display terminal previously associated with the operator's call terminal, in association with each other into a content share session information storage part, and transmitting same content when getting a WEB access from a user's display terminal and an operator's display terminal whose terminal identification information are recorded in association with same call session information,
the program comprising instructions for causing the computer to function as the content display terminal selecting unit for selecting user's display terminals able to display content sent via a network from among a plurality of user's terminals existing in a user environment, displaying a list of the user's display terminals, and causing the user to select a user's display terminal used for displaying content by using the list.

10. A non-transitory computer-readable medium storing a program comprising instructions for causing a computer to realize a server as a component of a content display terminal selection system comprising: a call information acquiring unit for acquiring call session information for identifying a call established between a user's call terminal used for calling by a user and an operator's call terminal used for calling by an operator; a content display terminal selecting unit for selecting user's display terminals able to display content sent via a network from among a plurality of user's terminals existing in a user environment, displaying a list of the user's display terminals, and causing the user to select a user's display terminal used for displaying content by using the list; and the server,
the program comprising instructions for causing the computer to functions as a session managing unit for recording the call session information acquired by the call information acquiring unit, terminal identification information showing the user's display terminal selected with the content display terminal selecting unit, and terminal identification information showing an operator's display terminal previously associated with the operator's call terminal, in association with each other into a content share session information storage part, and transmitting same content when getting a WEB access from a user's display terminal and an operator's display terminal whose terminal identification information are recorded in association with same call session information.
